(19) United States
(12) Patent Application Publication
(10) Pub. No.: US 2017/0243283 A1
(43) Pub. Date: Aug. 24, 2017

(54) Variable Price Purchasing System and Method

(71) Applicant: Christopher Calvin Boston, Brooklyn, NY (US)

(72) Inventor: Christopher Calvin Boston, Brooklyn, NY (US)

(21) Appl. No.: 15/438,816

(22) Filed: Feb. 22, 2017

Related U.S. Application Data
(60) Provisional application No. 62/298,598, filed on Feb. 23, 2016.

(51) Int. Cl. G06Q 30/08; G06Q 30/06

(52) U.S. Cl. CPC G06Q 30/08; G06Q 30/0609

(57) ABSTRACT

A variable price purchasing system and method. The system includes a processor; a database, and a logic that, when executed by the processor, causes the system to perform a method, the method including receiving a description of an item for sale from a seller; receiving an ideal price, negotiable price, and minimum price associated the item for sale; and receiving an offer for transaction of the item from a buyer. The ideal, negotiable, and minimum price are not revealed to the buyer. If the buyer's offer is greater than or equal to the ideal price, or between the negotiable price and ideal price, then the transaction is processed. If the buyer's offer is between the minimum price and the negotiable price, the seller is contacted for approval of the transaction. If the buyer's offer is less than the minimum price, then the transaction is declined.

### CROSS REFERENCE TO RELATED APPLICATIONS

This application claims the benefit of U.S. Provisional Application No. 62/298,598 filed on Feb. 23, 2016. The above identified patent application is herein incorporated by reference in its entirety to provide continuity of disclosure.

### FIELD OF THE INVENTION

The present invention relates to computer systems and methods. More specifically, the present invention provides a computer system and related method for conducting a transaction based on an offer for purchase made from a buyer, wherein the transaction is completed if a number of conditions have been met.

### BACKGROUND OF THE INVENTION

Buying and selling items generally involves a seller accepting an offer from a buyer. The modern price system utilizes fixed prices, wherein a seller displays or notifies a buyer of a single acceptable price the seller would be willing to accept for their goods or services. This system has several drawbacks. For instance, if a buyer is unwilling to pay the seller's listed price for an item, but is willing to pay a lower price, the seller might prefer to accept the lower price in exchange for winning the buyer's business. In a marketplace with fixed prices, such a negotiation is not facilitated. Further, some sellers may not have the resources or desire to determine a single acceptable price for a good, and instead would be willing to accept a sale price from a range of prices. It is therefore desirable to provide a variable price purchasing system and related method that allows for buyers to submit their own offer to purchase a good, wherein the seller may automatically accept or decline the buyer's offer depending on whether or not the offer falls within a predetermined range of prices.

Systems and methods have been disclosed in the known art that relate to transaction and purchasing systems. These include systems and methods that have been patented and published in patent application publications. These systems and methods generally relate to transaction systems having variable pricing, such as U.S. Pat. No. 8,676,654, U.S. Patent Application Publication Number 2014/0244404, U.S. Patent Application Publication Number 2011/0288951, U.S. Patent Application Publication Number 2014/0279172, U.S. Pat. No. 8,417,582, and U.S. Pat. No. 8,615,444.

The system and methods disclosed in the known art have several drawbacks. These systems and methods fail to allow a seller to input three prices, including a market price, negotiable price, and minimum price, and to accept offers based on where the offers fall between the three prices. Further, these systems and methods fail to facilitate communication between a buyer and seller when a buyer's offer price falls between a seller's minimum price and negotiable price.

In light of the systems and methods disclosed in the known art, it is submitted that the present invention substantially diverges in design elements from the known art and consequently it is clear that there is need in the art for an improvement to existing variable price purchasing systems and methods. In this regard the present invention substantially fulfills these needs.

### SUMMARY OF THE INVENTION

In view of the foregoing disadvantages inherent in the known types of purchase systems now present in the prior art, the present invention provides a variable price purchase system wherein the same can be utilized for providing convenience for the user when listing an item for sale without revealing the desired selling price.

The variable price purchase system includes a processor, a database comprising a non-transitory computer readable medium operatively connected to the processor, the database having a seller profile and a buyer profile stored thereon, and a logic stored in the non-transitory computer readable medium that, when executed by the processor, causes the computer system to perform a method. The method includes the steps of receiving a description of an item for sale from a seller, receiving an ideal price, a negotiable price, and a minimum price associated the item for sale, and receiving an offer for transaction of the item from a buyer. If the offer is greater than or equal to the ideal price, then the transaction is processed. If the offer is between the negotiable price and the ideal price, then the transaction is processed. If the offer is between the minimum price and the negotiable price, then the seller is contacted for approval of the transaction. If the offer is less than the minimum price, then the transaction is declined.

One object of the present invention is to provide a variable price purchasing system and method that is new and improved over purchasing systems and methods in the known art.

Another object of the present invention is to provide a variable price purchasing system that facilitates negotiation between a buyer and a seller if a buyer's initial offer falls within a range of values determined by the seller.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of the components of the variable price purchase system and method.

FIG. 2 shows a flowchart of the steps of the variable price purchase system and method.

### DETAILED DESCRIPTION OF THE INVENTION

Reference is made herein to the attached drawings. Like reference numerals are used throughout the drawings to depict like or similar elements of the variable price purchase system and method. For the purposes of presenting a brief and clear description of the present invention, the preferred embodiment will be discussed as used for conducting a transaction between a buyer and seller, wherein an offer is received from a buyer and compared to a range of values determined by the seller, which determines whether the transaction is automatically processed or denied. The figures are intended for representative purposes only and should not be considered to be limiting in any respect.

As used herein, “logic” refers to (i) logic implemented as computer instructions and/or data within one or more computer processes and/or (ii) logic implemented in electronic circuitry. As used herein, “computer-readable medium” excludes any transitory signals, but includes any non-transitory data storage circuitry, e.g., buffers, cache, and queues, within transceivers of transitory signals.

According to some embodiments, the operations, techniques, and/or components described herein can be implemented by an electronic device, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that incorporates hard-wired and/or program logic to implement the techniques and other features of the present disclosure.

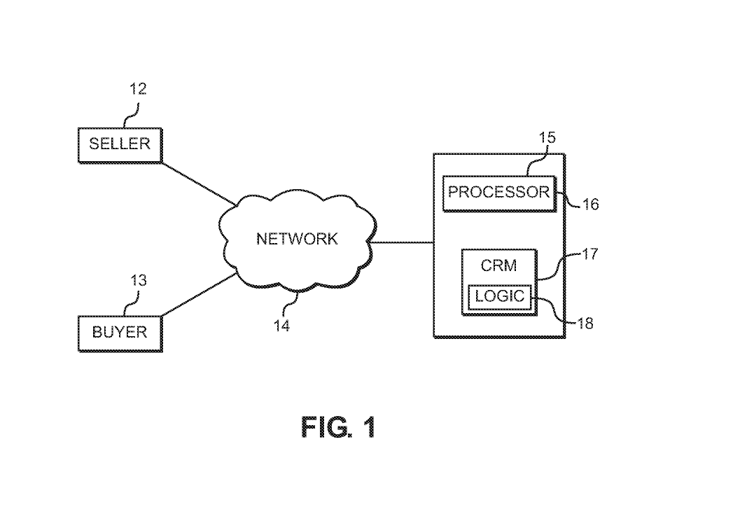

Referring now to FIG. 1, there is shown a diagram of the system components of the variable price purchase system and method. The variable price system comprises a database 15 having a processor 16, a non-transitory computer readable medium (hereinafter “CRM”) 17 operatively connected to the processor 16, and a logic 18 stored in the CRM 17 that, when executed by the processor 16, causes the variable price system to perform a method that facilitates a transaction between a buyer and a seller.

A seller device 12 and a buyer device 13 are each connected to a network 14, such as the internet. The database 15 is in operable communication with the same network 14 via a wireless transceiver 19 so that the database 15 may receive information from the seller device 12 and the buyer device 13. The CRM 17 further includes buyer and seller profiles stored thereon, wherein such information is received from the buyer device 13 and the seller device 12 prior to the conducting of a transaction. The buyer profile includes buyer contact information, deposit account information for receiving payments, and other relevant information. The seller profile includes seller contact information, payment information for paying for transactions, and other relevant information.

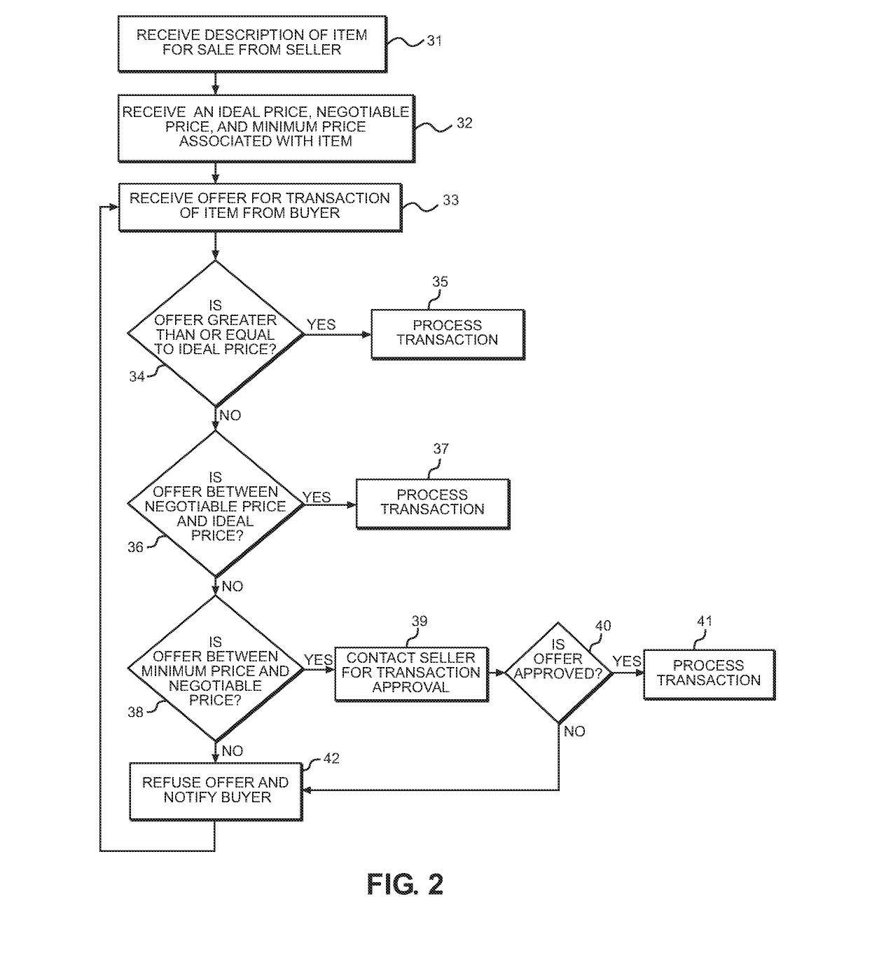

Referring now to FIG. 2, there is shown a flowchart of the method steps of the variable price purchasing system and method. The method includes a first step of receiving 31 a description of an item for sale from a seller. The description of the item should be detailed enough to inform buyers about the item should they wish to purchase it. A next step includes receiving 32 an ideal price, negotiable price, and minimum price associated with the item. The ideal price is comparable to the market price, or the price the seller would accept for the item if the item were on sale in a traditional fixed-price marketplace. The negotiable price is a lower price than the ideal price, but still an amount the seller would be willing to accept for the item. The minimum price is the lowest amount the seller would be willing to accept for the item, and may for example be the lowest amount a seller would accept for an item in order to avoid taking a loss on the item.

A third step includes receiving 33 an offer for transaction of the item from a buyer. The item the seller is selling, along with the description of the item, is viewable by the buyer via a website or other graphical user interface. However, the ideal, negotiable, and minimum prices the seller has provided for the item are hidden from the buyer. In this way, the buyer's initial offer is an estimate of what the buyer would be willing to pay for the item, which the buyer has derived without knowledge of the prices the seller would be willing to accept.

All of the information received by the system, including the buyer and seller profile information, the seller's item description and price information, and the buyer's offer information, may be received via voice recognition software, such as SIRI, Google Now, and other common voice recognition applications. The system is further configured to function with and receive inputs from these and other types of machine-learning applications. In this way, the present system is compatible with evolving information processing technologies.

Once the buyer's offer price is received, the transaction is either processed or declined based on whether or not the buyer's offer price falls within the seller's acceptable ranges. If the offer is greater than or equal to the ideal price 34, then the transaction is processed 35. Similarly, if the offer is between the negotiable price and the ideal price 36, then the transaction is processed 37. In other words, the negotiable price is the lowest purchase price the seller would be willing to automatically accept from the buyer.

If the offer is between the minimum price and the negotiable price 38, then the seller is contacted 39 for approval of the transaction. If the seller decides to approve 40 the buyer's offer without further negotiation, then the seller accepts the offer and the transaction is processed 41. If the seller does not approve 40 the buyer's initial offer, the offer is refused and the buyer is notified 42 of the cancellation of the transaction. The buyer is then free to submit another purchase offer at a higher price. Additionally, the notification may include a counteroffer from the seller that indicates a purchase price the seller would be willing to accept for the item.

In one embodiment, the method includes the additional step of calculating a transaction fee based on a percentage of the final purchase price. The seller is then contacted and prompted to pay the transaction fee. The transaction fee is paid to the entity that provides the marketplace, such as an online marketplace accessible via a website, which facilitates the transaction of goods utilizing a variable price purchasing system and method according to the present invention. In another embodiment of the invention, the transaction fee is automatically calculated and included in the overall price. In this embodiment, the buyer pays the transaction fee rather than the seller.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A computer system comprising:
a processor;
a database comprising a non-transitory computer readable medium operatively connected to the processor, the database having a seller profile and a buyer profile stored thereon;
a logic stored in the non-transitory computer readable medium that, when executed by the processor, causes the computer system to perform a method, the method comprising:
receiving a description of an item for sale from a seller;
receiving an ideal price, a negotiable price, and a minimum price associated with the item for sale;
receiving an offer for transaction of the item from a buyer;
if the offer is greater than or equal to the ideal price, then processing the transaction;
if the offer is between the negotiable price and the ideal price, then processing the transaction;
if the offer is between the minimum price and the negotiable price, then contacting the seller for approval of the transaction;
if the offer is less than the minimum price, then declining the transaction;

2) The computer system of claim 1, wherein the method further comprises:
if the transaction is declined, then sending a corresponding notification to the buyer.

3) The computer system of claim 2, wherein the method further comprises:
receiving a counter-offer from the buyer.

4) The computer system of claim 1, wherein the method further comprises:
if the transaction is processed, then calculating a transaction fee based on a percentage of the transaction price and;
requesting the transaction fee from the seller.

5) The computer system of claim 1, wherein the method further comprises:
if the transaction is processed, then calculating a transaction fee based on a percentage of the transaction price and;
requesting the transaction fee from the buyer.

6) The computer system of claim 1, wherein the database is configured to receive input via voice recognition software.

7) The computer system of claim 1, wherein the buyer profile and the seller profile comprise contact information and payment information.

8) The computer system of claim 1, further comprising a wireless transceiver configured to receive information via a wireless network and store the information on the database.

9) A computer-implemented method comprising:
receiving an item for sale from a seller;
receiving an ideal price, a negotiable price, and a minimum price associated with the item for sale;
receiving an offer for transaction of the item from a buyer;
if the offer is greater than or equal to the ideal price, then processing the transaction;
if the offer is between the negotiable price and the ideal price, then processing the transaction;
if the offer is between the minimum price and the negotiable price, then contacting the seller for approval of the transaction;
if the offer is less than the minimum price, then declining the transaction.

10) The computer-implemented method of claim 7, further comprising:
receiving a counter-offer from the buyer.

11) The computer-implemented method of claim 7, further comprising:
if the transaction is processed, then calculating a payment based on a percentage of the transaction price and;
requesting the payment from the seller.

12) The computer-implemented method of claim 7, further comprising:
if the transaction is processed, then calculating a payment based on a percentage of the transaction price and;
requesting the payment from the buyer.
